(19) United States
(12) Patent Application Publication
(10) Pub. No.: US 2012/0003364 A1
(43) Pub. Date: Jan. 5, 2012

(54) METHOD FOR SELECTING AND ARRANGING PROGRAM REPRESENTATIVES AND A COOKING DEVICE THEREFOR

(75) Inventors: Judith Kling, Landsberg/Lech (DE); Michael Greiner, Landsberg/Lech (DE); Peter Wiedemann, Klosterlechfeld (DE); Andre Juergens-Heinersdorff, Groebenzell (DE); Simon Seemueller, Bad Woerishofen (DE); Karin Klimm, Aitrang (DE)

(73) Assignee: Rational AG, Landsberg/Lech (DE)

(21) Appl. No.: 13/146,604

(22) PCT Filed: Jan. 27, 2010
(86) PCT No.: PCT/EP2010/050952

§ 371 Date: Sep. 21, 2011

(30) Foreign Application Priority Data
Jan. 27, 2009 (EP) 09001112.3

(51) Int. Cl. F24C 7/08; A23L 1/01; G07F 9/10

(52) U.S. Cl. 426/231; 99/357

(57) ABSTRACT

A method for selecting and arranging program representatives and a cooking device therefor including displaying program representatives on a display device, where the programs are for a cooking device, selecting program representatives via an input device, where the display device is connected to the input device and a control or regulating device, and storing the programs on a storage device, where the control or regulating device is connected to the storage device, the cooking device, or provided by the cooking device, and to the display device to display a program representative as a virtual token on a virtual token board on the display device. The method also includes placing the virtual token on an area of the virtual token board through various means, which enables a representation of a cooking process through the virtual token board to determine when and how to cook and item using the cooking device.

### CROSS-REFERENCE TO RELATED APPLICATIONS

This application is a national stage application of International Application No. PCT/EP2010/050952, filed on Jan. 27, 2010, which claims the benefit of European Patent Application No. 09001112.3, filed on Jan. 27, 2009, the entire contents of both applications are incorporated herein by reference in their entireties.

### BACKGROUND OF THE INVENTION

1. Field of the Invention

The embodiments of the present invention relate to a method for arranging representatives of programs that are selected by at least one input device from a plurality of programs for cooking devices on at least one display device. The display device is operatively connected to the input device and a control or regulating device. The control or regulating device is operatively connected to a storage device for storing a plurality of programs for cooking devices and is connected to at least one cooking device or is provided by a cooking device. Additionally, the embodiments of the present invention include a cooking device for implementing such a method.

2. Description of the Related Art

Cooking devices with which an input device including a display device is at least partially designed as a single part are well known in the prior art. For example, DE 20 2004 018 719 U1 describes an operating element for a cooking device comprising a touchscreen with a display field which comprises at least one touch element which can be actuated, the actuation of which enables a change of the display field to upstream or downstream elements of an operating menu.

A method for controlling a cooking procedure in a cooking chamber of a cooking device based on a plurality of parameters which can be entered via an input device of the cooking device is known from EP 1 989 978 A1, in which items to be cooked or cooking programs such as start and end times of the cooking and cooking parameters can be selected. For example, with a plurality of cooking programs, it can be indicated on an output device when which item to be cooked should be loaded into a cooking chamber, when it should be removed from the cooking chamber, and when a cooking sequence is desirable under certain parameters, such as the energy consumed by a cooking device, a time period required, or a weight loss of each item to be cooked can be optimized.

DE 10 2006 008 096 A1 describes a method for controlling cooking programs in a cooking chamber of a cooking device for different items to be cooked which are inserted at different points in time and on a plurality of treatment levels in a cooking chamber, wherein at a starting time point, the treatment levels which are to be loaded with items to be cooked at a later point in time are selected, and a cooking chamber climate is set depending on the loading. In the known method, signals can be emitted for a removal time of an item to be cooked or several items to be cooked from the cooking chamber.

DE 10 2006 039 235 A1 describes a method for representing an operating menu for cooking devices with an operating device, a cooking device with an operating device of this nature, an input device and, an output device, wherein the input device comprises touch switches and the output device is designed as a display for issuing image information. This method makes it possible to display an altered image on the output device on the basis of an entry on the input device, wherein the input device and the output device can be combined as a type of touchscreen. With the aid of a control device on the cooking device, images and symbols or similar can be altered on the display, depending on an input made.

In U.S. Pat. No. 5,111,028, a control system for a cooking device is described which, depending on the type of item to be cooked, can recommend an optimum position of the item to be cooked in a cooking device. Here, an input device and an output device can be used, by means of which the user can enter a plurality of items to be cooked or display items to be cooked which have been entered, and the optimization of the placement positions of a plurality of items to be cooked in a placement rack of the cooking device can be implemented according to parameters required by the user.

In EP 1 719 952 A2, a method is described for switching between display areas which each represent a cooking module, such as for two pans of a cooking device. Thus, information on both pans can be displayed in alteration via a display device, such as in the form of cooking parameters.

DE 202 03 117 U1 describes a system with several cooking devices and with at least one operating part, in which each cooking device and each operating part is coupled with a busbar via at least one interface.

In DE 10 2008 057 319, which is not published, a method for displaying work program stages of a cooking device is described, in which an operator of the cooking device is given a precise overview of the progression of the work program and its respective status while the work program is running. Every stage of a work program, which can comprise a plurality of stages, is displayed on a display device and the stage of the work program which is currently active or running is identified. This provides the operator with significant assistance in improving kitchen logistics, i.e., when planning production and work sequences in a kitchen.

DE 10 2008 032 453, which is not published, describes the use of a touchscreen for menu guidance of a cooking device, in which different levels of the operating menu can be shown as pages of a virtual book. By stroking areas of the touchscreen, the user can leaf between different operating menus on the same hierarchy level or on a different hierarchy level.

EP 1 798 479 A1 describes a method for operating a cooking device in which an item to be cooked is selected with an assigned cooking program, or at least a cooking program is selected with an assigned item to be cooked which is to be selected, and subsequently, the cooking device is loaded with the selected product. After starting the corresponding cooking program, a program name is displayed together with a residual cooking time on a display device of the cooking device, and subsequently an automated assignment occurs of further items to be cooked or cooking programs which match the cooking program of the first item to be cooked, depending on corresponding cooking parameters. This generic method is suitable for displaying the assigned items to be cooked and cooking programs to a user for further selection, in a time sequence of cooking programs at required time points, as well as for a plurality of items to be cooked which are located in the cooking device, wherein a respective residual cooking time of the selected items to be cooked can also be displayed.

The methods known in the prior art described above have the common feature that a visualization of the cooking programs is achieved by displaying a codeword and/or a graphic image. However, for many years a “token system” has been adopted in restaurant management. In this “token system,” if a guest in a restaurant selects an item on a menu, either the name of the item is written down on a note by the waiter, or another representative of the item, such as a number, is noted, and this note (token) is then attached to a board (token board) in a kitchen. In general, although this token system has been used successfully in the past, it has a disadvantage because handwritten notes are difficult to read. Additionally, notes (tokens) can be lost, and the information on the notes (tokens) still has to be passed on to a cooking device.

An electronic menu is described for example in DE 10 2007 040 652, which is not published. This enables direct communication between a restaurant guest and a cooking device.

In DE 10 2008 027 597, which is not published, the operation of a plurality of cooking devices via the same display device is described.

Methods for controlling the presentation of objects on a computer screen are known in many cases outside the cooking technology field, such as from U.S. Pat. No. 5,859,639.

### SUMMARY OF THE INVENTION

An object of the embodiments of the present invention is to further develop the generic method in such a manner that further simplification of the operability of a cooking device is possible. In particular, a simplification is desired when creating time sequence plans, function plans, and/or function sequences of programs for cooking devices.

This object is achieved according to the embodiments of the present invention in that the control or regulation device is operatively connected to the display device in such a manner that at least one representative program is displayed in the form of a virtual token in an area on a virtual token board shown on the display device. A token may be placed on the first section of the area by touching a first section of the area or approaching a first section of this area, and/or it may be moved from the second section into the third section by touching a second section of the area or approaching this second section of the area. A token may be moved via moving or stroking the token over to a third section of the area, and/or by touching at least a fourth section of the area or approaching or removing from this fourth section of the area, and/or at least one further input activity may be altered in its visual representation. The virtual token board enables a representation within a multidimensional area on the basis of a coordinate system with at least two position axes in order to determine a treatment zone of the cooking device, or at least one position axis is used to determine a treatment level, treatment gap or treatment line of the cooking area of the cooking device, and a time axis is used to determine at least one time point of the operation of the cooking device.

Here, it can be provided that each program is selected from a group comprising cooking programs (in particular, cooking mode types, cooking processes, cooking parameters, and/or items to be cooked), cleaning programs (in particular, by cleaning mode types, cleaning processes, cleaning parameters, and/or cleaning agents), auxiliary programs and/or diagnostics programs. Each virtual token comprises a code name and/or a graphic representation for the corresponding program.

According to an embodiment of the present invention, the coordinate system of the virtual token board determines at least one treatment level of a cooking chamber of the cooking device via a first position axis, and/or determines at least one treatment zone, in particular of a treatment level, of the cooking device via a second and/or third position axis, and/or determines at least one time point and/or a time period via a time axis at least of one selected program, function plan, and/or function sequence. The first, second, and/or third position axis and/or the time axis can be selected and/or altered. In particular, the axes can be scrolled along, and the time axis may alter (in stages or continuously) as a function of the time. Also, the axes of the coordinate system may run in a straight line and/or lie perpendicular with respect to each other.

Furthermore, in at least one virtual token bar in a further area of the display device, selectable virtual tokens and/or selected virtual tokens are displayed, where preferably, tokens in the token bar can be arranged below, alongside, and/or on top of each other. In particular, the tokens may be displayed in the chronology of the selection of the corresponding programs and may automatically depend on at least one priority parameter, such as by energy consumption, water consumption, cleaning agent consumption, time requirement, a target time, a start time, an area requirement, a reduction of weight loss of an item to be cooked, contamination, creation of smoke, an odor, and/or an improvement of a program result, such as the quality of a fully cooked item to be cooked and/or the cleanliness of a cooking chamber and/or a date of expiry, a sensitivity, a quantity and/or a price of an item to be cooked, and/or at least one climate parameter, determined by a temperature, humidity, pressure, flow speed and/or microwave energy.

With the embodiments of the present invention, a token may be selected by selecting a stored program, altering a stored program, and/or duplicating a token and/or compiling a new program, preferably via the input device. A token may be formed by at least two partial tokens, where at least one token or partial token is placed and/or displayed before a spatial and/or time-related arrangement on the virtual token board in the virtual token bar and/or according to a time and/or spatial assignment on the virtual token board in the virtual token bar, via an input device.

An alteration of a token, a partial token, a token board and/or a token bar via an input device may lead to an alteration in the visual representation, in particular determined by the size, color, hatching, pattern, form and/or brightness and/or the position on the display device and/or to an alteration of a program and/or program sequence, and/or must be confirmed by a person responsible for monitoring.

The embodiments of the present invention also may include touching, approaching, removing, stroking, pulling apart and/or drawing together, and/or a “drag and drop” procedure by moving an auxiliary tool (in particular in the form of a pen, pointer, finger and/or cursor) on a touchscreen. An enlargement may be achieved by an approach by a finger, or spreading apart by at least two fingers. A decrease in size may be achieved by a removal by a finger, or drawing together at least two fingers. A displacement and/or duplication may be achieved by a “drag and drop” procedure by a finger.

It can also be provided that a program alteration or program sequence alteration menu is used, where during the program alteration or program sequence alteration, the token board and/or the token bar are displaced or at least partially or sporadically reduced in size, enlarged, or visually suppressed.

Additionally, it can be provided that at least one token or partial token is visually emphasized after its selection, at least over a particular time period, for example by hatching, patterning, color and/or color intensity, a box frame, flashing, underlining or similar. The visual emphasis may be terminated automatically with a placement in the first section, a displacement from the second section into the third section, an alteration in the fourth section, and/or a positioning from the token bar into the token board.

In an embodiment of the present invention at least one token or partial token is automatically displaced by the control or regulation device from the token bar to the token board, following selection or duplication, either manually via a “drag and drop” procedure or depending on an automation parameter that may be determined by an access authorization, and/or a time period in which no entry is made in the input device, and/or by at least one priority parameter and/or climate parameter. Where preferably, a manual displacement is only made possible during the time period when the token is visually emphasized, and/or a duplication is affected by multiple touching of the token or by a further input activity.

Methods according to the embodiments of the present invention can also be characterized by at least one orientation line, preferably in the form of a snap line and/or as a critical path in the token board. In order to simplify the positioning of tokens or partial tokens using a “drag and drop” procedure, the orientation line may be at least partially displayed, in particular following a query via the input device. This may depend on the priority parameter and/or climate parameter, in particular with the design as a critical path, and/or where a plurality of orientation lines is selected in order to determine treatment zones and/or time points.

Furthermore, it can be provided that the priority parameter, climate parameter, automation parameter, and/or orientation lines can be selected and/or altered.

Additionally, it is recommended that the display device selectively displays at least one token, a partial token, a token bar, and/or a token board of a first or a second cooking device, or of at least two cooking devices.

The embodiments of the present invention also provide a cooking device with at least one function device for implementing at least one program and a control or regulation device which is operatively connected to an input device, a display device, a storage device and the function device in order to implement a method according to the embodiments of the present invention. The function device comprises a heating device comprising at least one electric heating element, a gas burner, a heat exchanger, and/or a device for radiating electromagnetic radiation into the cooking chamber in the form of a microwave source. The function device further includes a device for introducing humidity into the cooking chamber comprising at least one steam generator, a water atomizer and/or vaporization device, a device for removing humidity from the cooking chamber comprising at least one fresh air feed and/or a condenser, a device for circulating cooking chamber atmosphere comprising at least one fan and/or a pump, a device for applying pressure in the cooking chamber comprising at least one blocking device, and/or a cleaning device. The cooking device comprises the display device or it can be connected to the display device, and the input device or it can be connected to the input device. The cooking device further comprises the storage device or it can be connected to the storage device.

In the embodiments of the present invention, it can be provided that the cooking device, the control or regulation device, the display device, the input device, and/or the storage device can be connected to a plurality of further cooking devices in order to provide a kitchen network.

The embodiments of the present invention are based on the realization that an arrangement of program representatives can be achieved using simple measures, which may be a program representative in an area of a display device or to displace within the area, or altering a visual representation by touching a section of the area or approaching this section of the area with a finger. Here, it is particularly preferred when placing a program representative that a “drag and drop” method, which is well known when using graphic user interfaces of computers, is used for placing a program representative. A program representative can first be drawn away from the display device using a pointer tool, such as a finger, and can then be let go at a required position.

In order to realize the method according to the embodiments of the present invention, a representation of programs is provided, in particular cooking programs, preferably determined by cooking mode types, cooking processes, cooking parameters and/or items to be cooked. Also provided are cleaning programs, in particular determined by cleaning mode types, cleaning processes, cleaning parameters, and/or cleaning agents. Also provided are auxiliary programs, diagnostics programs and similar programs. The program representatives are in the form of virtual tokens in an at least a two-dimensional area in the form of a virtual token board with either a time axis and at least one position axis or at least two position axes. If appropriate, there may be additionally or at different times in a virtual token bar via a display device in order to simplify the operability of a cooking device, since to date, in restaurants, the standard tokens are used in digitalized form. Therefore, overall no retraining of kitchen staff is required, while at the same time, transfer errors can be reduced where a request made by a restaurant guest is displayed on a display device in a kitchen of a restaurant and can be directly processed. Compared to standard tokens, the virtual tokens can represent a larger number of programs, and be offered in a large number of different ways, including any forms, colors, patterns, brightness, sizes, or in 1, 2 or 3 dimensions, with or without markings, etc.

A virtual token board, which may be in the form of a planar or curved board which is itself cylindrical is graphically represented, can also be realized in a large number of different ways. For example, it can be shown on a display as a type of pinboard or a rotating drum as is known in gaming machines. The same applies to the representation of a virtual token bar which can also have different geometries and dimensions.

Virtual tokens can be arranged below, alongside, and/or on top of each other in the virtual token bar. They can be arranged in the chronology of the selection of the corresponding programs and/or depending on at least one optimization or priority parameter. The token bar can represent a type of selection window from which tokens can be transferred onto the token board, as will be described in greater detail below.

Furthermore, a simple time arrangement of virtual tokens on the virtual token board can be enabled with a time axis or a time bar, where each virtual token has a code name and/or a graphic representation for a program, and can be placed on the time bar or along the time bar. Here, at least one time point and/or one time period of at least one selected program, function plan, and/or function sequence can be visualized on the time bar. In this case, the token board represents a time window. Additionally, a simple spatial assignment of the virtual tokens to treatment levels of a plurality of treatment levels can be realized via one position axis, or an assignment to treatment zones of a plurality of treatment zones (such as in an insertion level or on a pan base) can be realized via two position axes. The virtual token board can also comprise position axes solely for determining treatment zones. The respective axes of the token board, selected from the time axis and/or each position axis, may stand vertically on top of each other. A right-angled or curved coordinate system can be spanned by the axes.

The virtual token board and/or the virtual token bar, and a function or sequence plan which can be determined by them and/or function sequence can be graphically represented on the display device and stored in a storage device. A stored function or sequence plan and/or function sequence can be retrieved or altered at any time.

Additionally, a further simplification of the creation of the sequence plan of programs, e.g., for cooking items to be cooked and/or implementing cooking programs, cooking mode types, cooking processes, and/or cooking stages, can be achieved when a shared input and display device in the form of a sensor screen or touchscreen intuitively enables a user to place the virtual tokens on the virtual token board. A user places the virtual tokens on the virtual token board from the virtual token bar, along the time axis or time bar to the position coordinate or along a first position axis to a coordinate of a second position axis, for example using “drag and drop” and/or by touching, approaching, removing, stroking, drawing apart, and/or drawing together fingers. A representation of the virtual token which is expressed in terms of color and/or geometry may support an intuitive assignment of items to be cooked jointly and/or cooking programs and/or cooking stages which are to be implemented simultaneously.

The display device can be provided on a cooking device according to the embodiments of the present invention. It can, however, also aid communication with a plurality of cooking devices that are actively connected to each other. The cooking devices may also be different, e.g., they can fulfill the function of as the following devices: SelfCooking Center® or Vario-Cooking Center®. Each cooking device according to the embodiments of the present invention can be equipped with an input device and/or be operable via a remote input device, where the remote input device can be designed in the form of an electronic menu. It is also feasible that the display device and input device are designed in the form of a touchscreen as part of a cooking device and/or independently designed to communicate via cable or in a wireless manner with at least one cooking device. If only one display device is used for several cooking devices, either the display of information for one cooking device can be selected, or information regarding several cooking devices can be displayed simultaneously.

If the method according to the embodiments of the present invention is used for creating a joint sequence plan for a plurality of cooking devices that are networked with each other, the control, display and/or creation of sequence plans for each cooking device connected to the display and input device can also be conducted via a display and input device in the form of a touchscreen. In order to alternate the control display and/or creation of sequence plans between different cooking devices, a button, switch, or similar can be provided, where the option of “paging” between menu levels of different cooking devices also exists via the use of a touchscreen.

It is also possible to represent the virtual token board on a first area of the display device and/or to represent the virtual token bar on a second area of the display device. To achieve this, a selection can be made when the first and/or second area is displayed, and/or in which a size, color, form, and/or brightness in the first and/or second area is displayed. It can also be provided that it can be freely selected where the first and/or second area is displayed. Naturally, the arrangement of the areas on the display device can be freely selected and altered.

A virtual token, for example, a token representing the cooking of an item to be cooked that is determined by a cooking program, can be created by a user by selecting a cooking program, e.g., selecting a cooking mode type, such as “meat.” A user then selects a cooking process, such as “roasting,” and finally, a user selects at least one cooking parameter, such as “degree of browning” and/or a “core temperature.” Alternatively, a token can be selected from a plurality of stored tokens, or maintained by duplicating or altering another token. The virtual tokens selected can then be represented on a virtual token board and/or in a virtual token bar in the display area of the input and display device.

A cooking program can, e.g., be selected in such a manner that a user is shown the operating modes which can be implemented by the cooking device according to the embodiments of the present invention on a main operating menu on the touchscreen. For example, a user makes a first selection by touching an operating field, e.g., in the form of a digital button, from a plurality of operating fields representing cooking operating modes via letters, numbers, colors, symbols, and/or geometric forms. Subsequently, a first sub operating menu can open as an option, where the processes that correspond to the selected operating modes appear, which allows the process to be selected via operating fields. It can be provided that for further settings, e.g., for the setting of a cooking parameter, at least one second sub operating menu can be opened. The selected cooking program can comprise a plurality of cooking stages, where each cooking stage represents a program section.

It can be provided by a cooking device according to the embodiments of the present invention prior to the creation of a virtual token that a user must confirm a selection which has been made. As an alternative, temporary virtual tokens which have not yet been confirmed can be created, where confirmed and not yet confirmed tokens can differ in their manner of visualization. Furthermore, it can be provided that confirmed or not yet confirmed virtual tokens can be differentiated by the user on the display device, in particular on the token bar, by means of a separate graphic display. It is clear that any number of programs can be represented as virtual tokens, e.g., in the form of cooking programs. Furthermore, as many virtual tokens as required may be placed on the virtual token board.

A graphic representation of virtual tokens can stand out using visual emphasis, e.g., using a geometric form, size, change in hatching, box frame, flashing, underlining, pattern, color intensity, and/or a color. It can be provided that virtual tokens for items that are cooked in a certain cooking chamber climate are identified by a corresponding color or pattern that represents the specific cooking chamber climate. The progression during a program sequence can also be visually emphasized. Furthermore, it can be provided that tokens relating to items to be cooked which must run through more than one cooking stage before they are fully cooked are displayed in at least two colors, where, for example, a site of a change of the visual emphasis displays a change in the cooking chamber climate. It is also feasible that virtual tokens are identified in several colors or patterns in such a manner that a series of required cooking chamber climates can be recognized. For example, a cooking chamber climate in which both “fish” and “poultry” can be roasted may be shown in red. A “steaming mode,” which requires a different cooking chamber climate, may be shown in blue. A color representation of virtual tokens can be achieved in such a manner that a cooking chamber climate that is first required is shown to the left on a virtual token, and the subsequent cooking chamber climates are shown from left to right on the virtual token. The progression of a cooking program can also be shown on each token by altering the markings or via a progression bar, an arrow, or similar.

A representation of the time progression of virtual tokens can be achieved in such a manner that a fixed, scalable time window over a certain time period (for example for three hours) can be shown using the time axis on the display device. The fixed time window thus shows only a section of a production plan, which is intended, for example, to cover the kitchen management for one day, so that the programs respectively running (such as cooking programs) can run automatically in specific time intervals (such as from right to left) through the production plan section shown in the time window (preferably in real time). Here, it can be provided that the time intervals are correspondingly short so that the movement of the virtual token shown in the time window runs smoothly for the human eye to see. It can also be provided that the time window shown can be reduced in size and/or enlarged, whereby, for example, it is scaled using gesture control. Additionally, an alternative time section of the production plan may be shown in the time window by touching the time window with a finger, and then moving the finger. It is also possible that another time section can be set by directly entering a start and/or end time point or an alternative time period. Additionally, an enlargement and/or reduction in size is possible using a symbolized magnifying glass function. Zooming with two fingers is also possible.

Furthermore, it can be provided that no fixed time window is shown, but that by touching a sensor screen or touchscreen with a finger and then moving the finger, areas which lie in the past can be made visible again, or areas which are intended to run in the future can be shown by moving the time window along the time bar which can be shown by means of a time axis. Scrolling through the time axis is thus possible.

It is also possible that one or more partial areas can be visually emphasized in the time window. For example, an enlargement or zoom function can be provided that makes it possible to show in an enlarged version in the time window virtual tokens, texts or similar items which are located inside the zoom area, or which move into this area. Alternatively, an enlargement, a reduction in size, flashing, box frame, color change, brightness change, and/or an additional symbol are feasible as a visual emphasis. If virtual tokens leave the zoom area, the display can reduce them back to their original size automatically. Furthermore, both the position of the partial area with the zoom function can be determined, as well as its time expansion. The zoom area may be determined by the user turning a setting wheel, or by moving the zoom area with a gesture control in accordance with the functions described for moving a time section shown in a time window. Here, it is clear that a position and a width of the zoom area can be freely selected. Also, touching a virtual token may directly result in an enlarged representation. Furthermore, it is clear that a degree of enlargement and/or size reduction in the zoom area can be freely selected.

It can also be provided that virtual tokens can be differentiated on the basis of their geometric form. In general, any geometric forms are suitable for differentiating the virtual tokens. Furthermore, it can be provided that the geometric form of the virtual tokens makes it possible to reach a decision regarding any one or all of the following: an optimum cooking sequence in order to optimize the use of resources, a time plan, a program result, in order to reduce the loss of weight in an item to be cooked, contamination, smoke creation, or an odor. The geometric form of the virtual token makes a certain cooking sequence clear to the user, for example, via a graphically displayed key and lock symbol on a left and/or right edge of the virtual token. Here, a characteristic parameter for the corresponding program can be visualized via the geometric shape, where on at least one token bar, virtual tokens of the selected programs are shown that correspond to at least one parameter of the program and/or in the arrangement to at least one position axis and/or to the time axis. Furthermore, it can be provided that a combination including a specific geometric form on a left and/or a right edge of a virtual token and a color marking is possible.

Here, it is clear that a correspondence between a right edge of a first virtual token and a left edge of a second virtual token, and/or a color correspondence between the right edge of the first virtual token and the left edge of the second virtual token, can represent an optimum implementation sequence of programs, in particular cooking programs. If no correspondence between the edge areas is present, there is no optimum sequence, and for example, the climate in the cooking chamber may need to be adjusted. Furthermore, it should be noted that the time progression of a cooking program can not only be shown from left to right on a token, but that other forms of marking are also possible, such as from top to bottom or similar.

It can furthermore be provided that instead of or in addition to the described color marking and the specific geometry on the left and right edge, alternative graphic markings of the virtual tokens are used in order to convey further information to the user. On the virtual token board, any number of virtual tokens required can be placed, depending on the type and number of cooking devices according to the embodiments of the present invention which are actively connected to them. For a differentiation of the virtual tokens on the virtual token board, it can be provided that a marking of the virtual tokens is made with a label and/or a symbol representing the respective cooking device. For example, the marking may be shown next to and/or close to the respective virtual token.

It can also be provided that via an input device, virtual tokens can be enlarged, reduced in size, and/or altered with regard to their color, pattern, position, and/or their geometric shape.

Furthermore, it can be provided that virtual tokens on the virtual token board can be pre-sorted by the user using “drag and drop.” A pre-sorting of this nature in accordance with the priorities of the user can simplify a subsequent creation of a sequence plan. Additionally, when the user operates the touchscreen and/or activates a separate input device, a targeted enlargement and/or size reduction of the representation of the virtual token on the virtual token board can be possible, where the degree of enlargement or reduction in size can be individually set by the user. Furthermore, it is provided that only a certain number of virtual tokens is shown on the virtual token board, and the user makes a selection of the virtual tokens to be shown by making an entry on a regulator, which is optionally a virtual regulator (e.g., in the form of a rotary knob, a rotary regulator, a slide regulator, and/or a rotary wheel). Other selection methods, such as “touching” or “marking” an area with one or more fingers are also possible.

It can also be provided that at least one area is designed as a display alteration area on a display device in such a manner that at least one virtual token board and/or one virtual token bar can be pulled onto this display alteration area using “drag and drop.” Thus, the virtual token board and/or the virtual token bar can be changed in a simple manner from a first pan to a second pan, and/or from a first level to a second level of a cooking device. Furthermore, the area can also be designed to enable a corresponding change between at least two cooking devices.

Changing a virtual token, token board, and/or token bar, in particular, by moving onto a display alteration area, can lead to an alteration in the visual representation. In particular, it can be determined by the size, color, pattern, hatching, form, brightness, and/or the position of the areas shown on the display device.

Instead of moving a virtual token board and/or a virtual token bar, individual virtual tokens can also be moved using “drag and drop” onto an area provided for a change, e.g., between pans, levels, and/or cooking devices. Here, moving a virtual token from a first virtual token board onto the area of a display change can lead to a placement of the virtual token on a second virtual token board. Several areas can also be provided on an input and display device so that each area can stand for a specific pan, level, and/or cooking device.

It is also possible to subsequently change the display of the levels, pans, and/or devices shown.

The virtual tokens shown in the virtual token bar are preferably all shown in the same width. However, the width of the tokens may also differ, and serve to display the duration of the corresponding program. Accordingly, a token for a longer program would be wider than the token for a short program. It can also be provided that the width of the tokens is set depending on the duration of the corresponding program when the tokens are placed along a time bar and/or on a token board.

Thus, the user can be informed of the implementation time required in each case via a change in the width of the virtual token. For example, while all virtual tokens on the virtual token bar preferably have the same width, this width is shown when they are placed on the time bar in a manner according to the relationship of the duration of the respective cooking stages.

The height of the virtual tokens shown may contain information regarding the amount of space required (for example, a required number of insertion levels of a cooking device according to the embodiments of the present invention). A virtual token which is double the height requires double the number of insertion levels of a cooking device according to an embodiment of the present invention. A corresponding visualization of treatment zones in a treatment level is also feasible, e.g., using a variable depth of the tokens.

Furthermore, it is possible that a virtual token is divided into at least two virtual partial tokens, which correspond to the different cooking stages for a cooking program, where preferably, partial tokens for program stages that can be separated in time from each other can be shown in separate spaces on the display device. Here, it can be provided that a color and/or geometric marking of the partial virtual tokens is conducted. For example, a virtual token for a cooking program including a first cooking stage “steaming” that constitutes a third of the required overall cooking time, and a second cooking stage “roasting” that constitutes the remaining cooking time, are marked in a color in such a manner that a first third of the virtual token on the left-hand side is shown in one color, which is clearly different from the color of the subsequent two-thirds of the virtual token. Due to this type of color marking, it can already be seen on the virtual token board which time portion is required for the different cooking stages of the virtual token. A possible division of a virtual token can be clarified by a symbolic division line.

It is also provided that a virtual token can be shown prior to a time-related and/or space-related arrangement on at least one virtual token board in at least one virtual token bar.

In order to create a sequence plan for implementing programs represented by virtual tokens (e.g., in the form of cooking programs in a cooking device according to the embodiments of the present invention), a graphic arrangement of the virtual tokens on a time bar, which is optionally limited by a start time and/or an end time, can be made in such a manner that a user places the virtual tokens from the virtual token bar at required points in time and in a required sequence along the time bar in the virtual token board using “drag and drop.” If a cooking device according to the embodiments of the present invention has more than one treatment level (e.g., it has several insertion levels), these insertion levels are shown in accordance with a coordinate system including a time axis in the form of a time bar and a position axis for the insertion levels (i.e., two-dimensionally). Furthermore, if a plurality of treatment zones is provided in each insertion level, this can be reflected by at least one position axis so that ultimately a three-dimensional representation of the virtual token board is created.

As an alternative to a three-dimensional representation, it can be provided that following a selection of an insertion level, a change in the representation is made instead of a representation of a second position axis in such a manner that in a display area a selected area is shown in which a plurality of treatment zones is displayed (e.g., using a pictogram representation). Here, the time axis continues to be shown in the form of a time bar, and virtual tokens can be placed on the treatment zones represented by pictograms. Here, when transferring the virtual tokens from the virtual token bar, the number of treatment zones required may be identified. An alteration between representations may be achieved by touching an input field, turning a rotary regulator, and/or automatically when virtually placing a token on an insertion level.

Representations are also feasible without a time axis, where treatment zones are characterized in a cooking device using position axes.

Even four-dimensional representations are possible, namely with three spatial dimensions and one time dimension. Within a multi-dimensional space, representations can be projected into lower dimensions moved, reduced in size, and/or enlarged (analogous to the handling of a time window described above).

It is also possible to change the representation, either manually or automatically, depending on the selected program. Furthermore, a first representation can be shown on a small scale, and a second representation can be shown on a large scale, where the size can be altered, for example, by zooming, pulling apart or drawing together at least two fingers, or by changing a position using a “drag and drop” method.

The creation of a sequence plan by the user is simplified by the graphic features of the virtual token described, such as a color marking, specific geometric forms, or virtual partial tokens. It can also be provided that an arrangement occurs depending on at least one parameter of at least one virtual token arranged on a virtual token board. For example, an arrangement of one other virtual token which is to be arranged on this token board occurs with at least one other parameter, and each parameter is at least a characteristic of a cooking device, a function device of the cooking device, a treatment level of the cooking device, a treatment zone of the treatment level, a time point, a time period, a prioritization, and/or a climate value of the program that corresponds to the respective virtual token.

The creation of the sequence plan can preferably be further simplified by automatically denying a placement of virtual tokens with different colors and/or geometries, where each requires different cooking chamber climates, either below each other, above each other, or partially intersecting at the same time point on the time bar at different treatment zones or the same treatment zone.

As has been mentioned above, it can be provided that virtual tokens can be prioritized using a priority parameter, where the parameter characteristic for a prioritization (priority parameter) is determined by energy consumption, water consumption, cleaning agent consumption, a time requirement, a target time, a start time, a spatial requirement, a reduction of a loss of weight of the item to be cooked, contamination, creation of smoke and/or an odor, and/or an improvement in a program result (such as the quality of a fully cooked item to be cooked and/or the cleanliness of a cooking chamber). For example, energy consumption can be efficiently set, a time requirement can be reduced, and the further priority parameters can enable targeted optimization measures to be implemented. A goods management system can also determine priority parameters. However, this may depend on an expiration date, a sensitivity, a quantity, a price, or similar, of an item to be cooked.

The positioning of a first virtual token with a higher priority in terms of space and/or time with an already positioned second virtual token with a lower priority can itself lead to an automatic re-arrangement of the second virtual token.

A parameter which is characteristic for a climate value (climate parameter), determined by temperature, degree of humidity, pressure, flow speed, and/or microwave energy in a cooking device, in particular in a treatment level and/or treatment zone, can also be taken into account, either alternatively or cumulatively.

Furthermore, the user can be provided with a supporting function that shows orientation lines in the form of “snap lines” that correspond to a start or end time of a virtual token. If a user moves a virtual token (e.g., from the virtual token bar to a required position on a virtual token board using “drag and drop”), the snap lines are shown as an orientation for possible placement points.

For example, it is possible for snap lines to be shown which relate to reference time points on a time bar that are determined by a user. This can simplify the completion of cooking stages at certain time points. The snap lines are shown, e.g., on the left and right end of the virtual tokens or partial tokens vertical to the time axis.

Furthermore, it can be provided that for a cooking device according to the embodiments of the present invention which has more than one insertion level, additional snap lines are shown horizontally along the lower and/or upper end of the virtual token at least periodically, preferably on request. It can also be provided that snap lines which represent a restriction of insertion levels are shown permanently. If a user “releases” a virtual token at a certain distance from the snap line, for example, the virtual token can automatically be arranged according to the closest snap lines. The snap lines are also shown as an option when virtual tokens are moved within a sequence plan.

It is also possible to arrange the virtual partial tokens at different time points on a sequence plan, and to align snap lines. This can occur, for example, when an item to be cooked requires an interim treatment stage outside of a cooking device, and subsequent to the interim treatment stage, the cooking device must again be loaded with the item to be cooked. However, pre-cooking and finishing can also be represented using two virtual partial tokens.

It is also possible that the progress during the sequence of a selected program, function plan, and/or function sequence is shown in the area, for example, by means of at least one time indicator along the time axis.

Additionally, it can be provided that sequential progress bars are shown on, adjacent to, and/or close to the respective virtual tokens which can represent the progress of the respective cooking stages of the virtual tokens. Alternatively, or in addition to the display of progress bars, it is also possible to show a numeric residual time display on, adjacent to, or close to the respective virtual tokens. It can also be provided that a sequential progress bar is graphically shown for all virtual tokens together, or to show a shared residual cooking time. It is clear that any graphic representation of residual cooking times is possible, e.g., using an analogous clock, kitchen items, or similar. In all cases, both a progress and a residual cooking time can be regarded as program parameters which can be visualized on a token and/or partial token in the form of an additional marking.

All the information necessary for a work program can be displayed on a token, selectively and/or at least at certain times, for example, after touching the token, enlarging the token, or similar. This information can contain cooking parameters such as a required internal degree of cooking (e.g., in the form of a core temperature), and a required external degree of cooking (e.g., in the form of browning), and can be altered selectively, such as after touching the token.

Furthermore, it is possible to show a user a critical path of the virtual tokens or partial tokens, which makes it clear to the user that all virtual tokens or partial tokens which are emphasized by the critical path must be loaded and/or unloaded at precisely the entered times in order to maintain the overall sequence plan. A delay in the sequence of the critical path should therefore be avoided to the extent possible. A critical path can thus identify programs to be prioritized, so that the critical path can also be regarded as an additional marking of a token and/or a partial token, and it can depend on the corresponding priority parameters and/or climate parameters. The critical path can also be designed as an orientation line, preferably in the form of a snap line.

An automatic creation of a sequence plan by a cooking device according to the embodiments of the present invention is also possible. For the automated creation of the sequence plan, virtual tokens may be optimally arranged on the virtual token board, depending on parameters selected by a user. An automatic arrangement may be completed which takes energy aspects into account, or the shortest possible time for use of the device, and/or a minimum work period. In general, an optimization of the arrangement can also be provided on the basis of other parameters (priority parameters) which are suitable for an optimization of a time sequence of virtual tokens.

Instead of specifying time points, defined intervals between individual tokens (e.g., every 2 minutes), can be specified and regarded as an optimization. Alternatively, interval tokens can be created which represent an interval program.

It can also be provided that a user specifies any number of virtual tokens for a certain time point. For example, these can be virtual tokens which represent dishes for a lunch buffet that must be fully cooked at a fixed point in time. Further individual orders made by restaurant guests can then, for example, be automatically arranged by a cooking device according to the embodiments of the present invention in an optimum manner around the virtual tokens that relate to a fixed time. Furthermore, it can be provided that a graphic differentiation is made between fixed time and variable time virtual tokens.

Furthermore, it can be provided that an automatic re-arrangement of a sequence plan can be conducted following re-prioritization by the user. If a user wishes to conduct a manual re-prioritization of the virtual tokens, this can lead to a new automatically optimized sequence (e.g., of all non-manually re-arranged virtual tokens). Furthermore, a user may subsequently change selected priority parameters, in accordance with a re-prioritization, and a new sequence plan is then automatically created in accordance with the altered parameters.

In general, optimization methods that may be required for the automatic arrangement of the virtual tokens described are well known in the prior art. In particular, the use of linear optimization methods, such as simplex methods, internal point methods, and/or ellipsoid methods can be provided in an item to be cooked in the cooking device according to the embodiments of the present invention.

Further features and advantages of the embodiments of the present invention are included in the description below, in which exemplary embodiments of the present invention are explained with reference to the accompanying figures described below.

### BRIEF DESCRIPTION OF THE DRAWINGS

FIG. 1 shows an input and display device in the form of a touchscreen of a cooking device according to an embodiment of the present invention, on which a main operating menu is shown;

FIG. 2 shows the touchscreen shown in FIG. 1, in which a first sub operating menu is open;

FIG. 3 shows the touchscreen shown in FIG. 1, in which a second sub operating menu is open;

FIG. 4 shows the touchscreen shown in FIG. 1, in which cooking programs are shown in a virtual token bar;

FIG. 5 shows virtual tokens for cooking programs with different colors, according to an embodiment of the present invention;

FIG. 6 shows an arrangement of virtual tokens for cooking programs shown in FIG. 5 on the basis of their color marking;

FIG. 7 shows virtual tokens for cooking programs with different geometric shapes, according to an embodiment of the present invention;

FIG. 8 shows a possible arrangement of virtual tokens for cooking programs shown in FIG. 7 on the basis of their geometric form;

FIG. 9 shows the touchscreen shown in FIG. 1 with a representation of a first time and spatial arrangement of tokens in a virtual token board and a virtual token bar;

FIG. 10 shows the touchscreen shown in FIG. 1 with a representation of a second time and spatial arrangement of tokens in a token board and a token bar;

FIG. 11 shows virtual tokens for cooking programs with different time arrangements, but the same spatial arrangements, according to an embodiment of the present invention;

FIG. 12 shows virtual tokens for cooking programs with different time arrangements, but the same spatial arrangements, according to an embodiment of the present invention;

FIG. 13 shows a system of networked cooking devices with a shared input and display device, according to an embodiment of the present invention;

FIG. 14 shows a representation of an automatically optimized sequence plan with virtual tokens with a fixed time, according to an embodiment of the present invention;

FIG. 15 shows a touchscreen which represents treatment zones in insertion levels for a time arrangement of virtual tokens, according to an embodiment of the present invention;

FIG. 16 shows the touchscreen shown in FIG. 1 with a representation of display alteration areas between levels and/or pans of a cooking device and/or cooking devices;

FIG. 17 shows the touchscreen shown in FIG. 1 with a representation of display alteration areas between levels and/or pans of a cooking device and/or cooking devices; and

FIG. 18 shows the touchscreen shown in FIG. 1 with a representation of display alteration areas between levels and/or pans of a cooking device and/or cooking devices.

### DETAILED DESCRIPTION

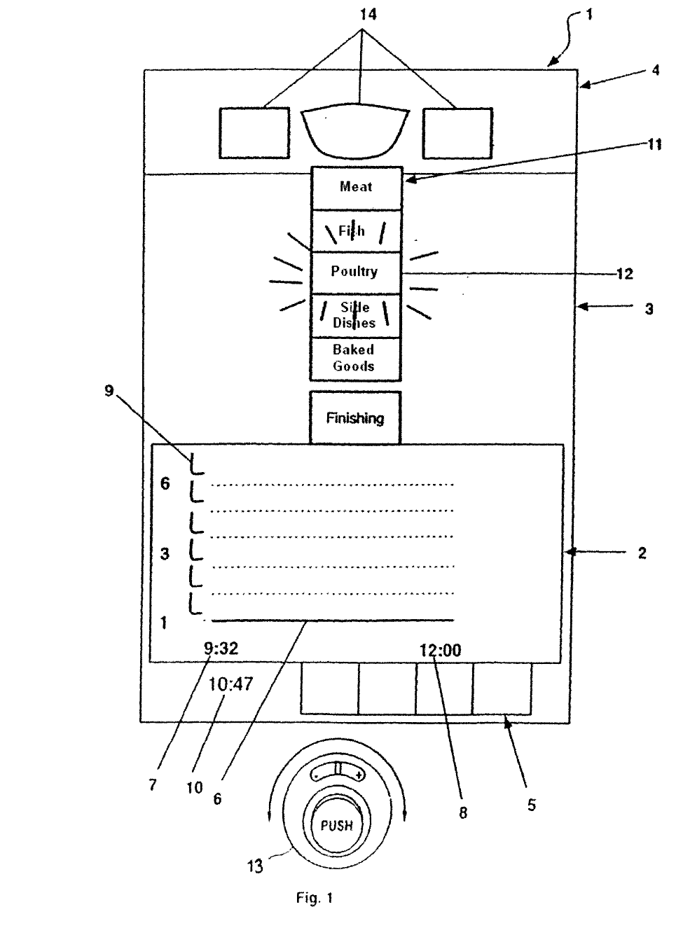

The input and display device shown in FIG. 1 in the form of a sensor screen or touchscreen 1 of a cooking device according to the embodiments of the present invention comprises a first display area 2 for a virtual token board (described in detail below), a second display area 3 for selecting cooking programs, and a third display area 4 for selecting a mode of the cooking device. Below the first display area 2, four square touch elements are located in the form of digital buttons 5 which can be assigned additional functions as required, such as a cleaning function, a help function, a menu level change function, and the like. Within the first display area 2, a time bar 6 is located on which a time progression of cooking programs running in the cooking device can be shown. The time bar 6 has a display of a start time point 7 and at least one further orientation time point 8, which can, for example, correspond to a time point at which items to be cooked should be fully cooked. A cooking device according to the embodiments of the present invention can also have several (e.g., six) insertion or loading levels 9 for items to be cooked in which several cooking programs can run substantially parallel to each other. The cooking device can, for example, be a cooking device for treating items to be cooked with hot air and/or steam, as with the “Self-Cooking Center®.”

For improved time orientation, the user can be shown the current time 10. Furthermore, the remaining residual cooking time of one or more cooking programs, or the residual cooking time of all cooking programs running in a cooking device according to the embodiments of the present invention may be shown to the user.

In the second display area 3, the user is provided for selection with at least one, and in the case shown in FIG. 1, six different touch or selection elements 11 for different cooking mode types of the cooking device according to the embodiments of the present invention, such as “meat,” “fish,” “poultry,” “side dishes,” “baked items,” or “finishing.”

A required cooking mode type can, for example, be selected by the user by touching one of the cooking mode type selection elements 11. After a user has selected a cooking mode type, the selection element 11 of the selected cooking mode type 12 is visually marked, for example, by flashing, as is symbolized in FIG. 1 for “poultry.” It is clearly visible that a plurality of further display or selection elements can be provided. A selection can, for example, also be made using a rotary knob 13, where arrows designate the possible rotation directions of the rotary knob 13. The rotary knob 13 may also be in the form of a virtual rotary knob.

The selection elements 11 shown for different cooking mode types are those elements which can be shown, for example, after switching on the cooking device according to the embodiments of the present invention, and/or after the selection of a mode via one of the display fields 14 located in the third display area 4 (e.g., for a semi-automated intelligent mode).

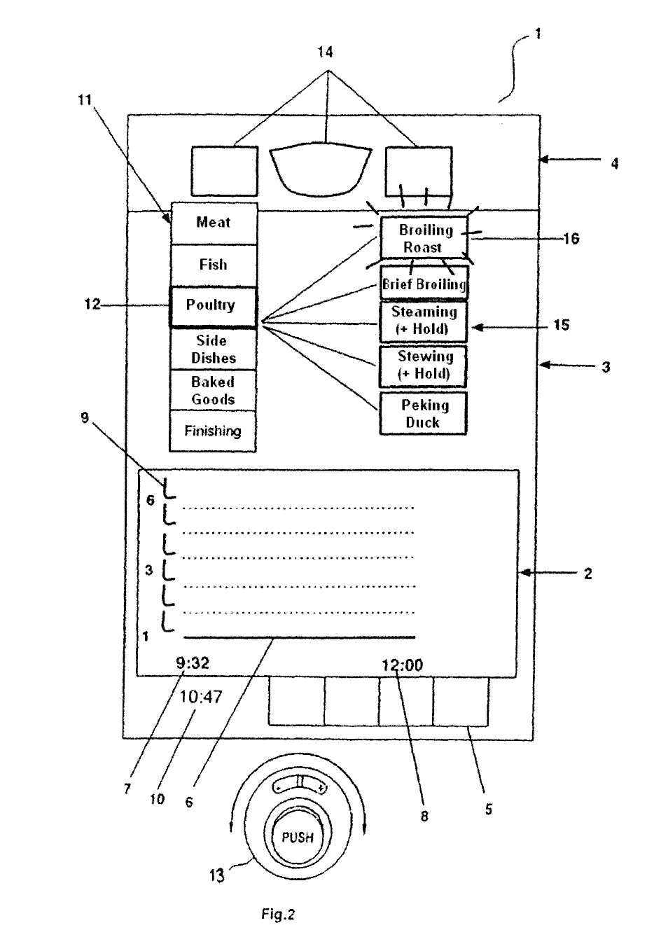

After the user of the cooking device has selected “poultry” as a cooking mode type, a first sub operation menu for this selected cooking mode type opens as shown in FIG. 2, with selection elements 15 for cooking processes such as “broiling roast,” “brief broiling,” “steaming (+hold),” “stewing (+hold),” and “Peking duck.”

As an alternative to the letters or codewords shown in FIGS. 1 and 2 to label the selection elements 11, 15 for the cooking mode types and cooking processes, symbols and/or numbers can also be displayed. For example, illustrations of the respective items to be cooked can be shown. It is clear that a plurality of cooking processes, which are not shown in the figures, can also be provided for in the display. It can also be sufficient when selecting a cooking program that only one cooking mode type is selected, such as “finishing,” so that selecting a cooking process is not required, and thus, no first sub operating menu level opens.

The arrangement of the operating menu with selection elements 11, 15 for cooking operating modes and cooking processes shown in FIG. 2 is only an example, and any number of graphic arrangements for the selection elements 11, 15 are possible.

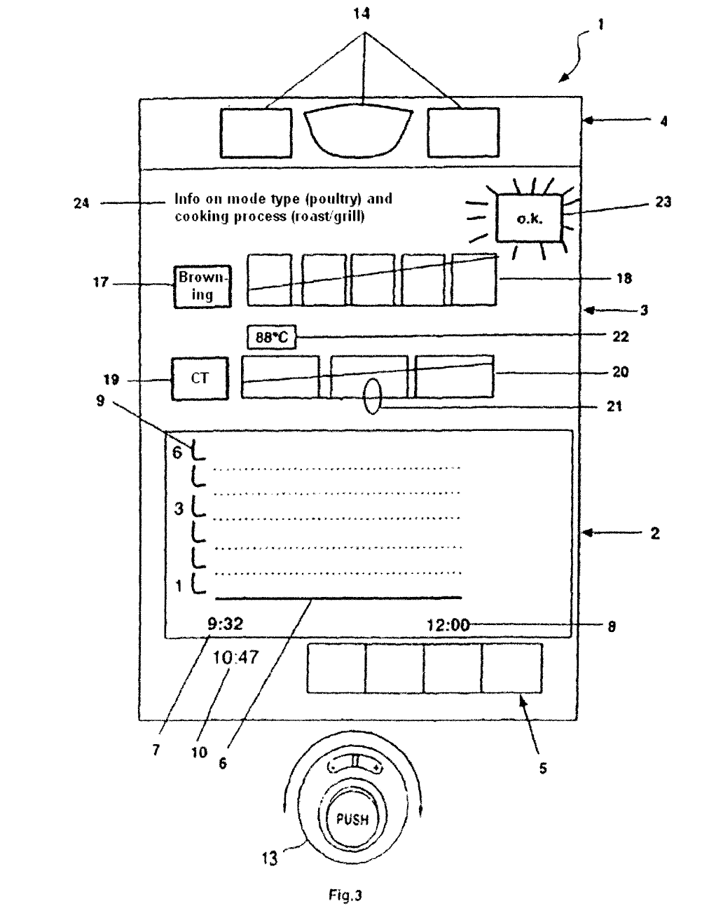

If the user makes a confirmation by touching the selection element 16 “broiling roast,” this selected cooking process can be visually emphasized, e.g., by flashing as shown in FIG. 2, and a second sub operating menu can open, as shown in FIG. 3.

The second sub operating menu shown in FIG. 3 comprises further display elements 17, 18, 19, 20, 21 for selecting cooking parameters which are suitable for roasting or grilling poultry, namely a browning display element 17, together with a browning intensity display element 18, and a core temperature display element 19, together with a core temperature level display element 20. The user can now touch one of the browning intensity display elements 20, and by means of a selection element 21 in the form of a slide rule, set the required core temperature for an item to be cooked. Alongside the graphic representation of the selected browning intensity and core temperature, the selected values can also be shown numerically to the user, for example, via a display element 22 for the selected core temperature.

After the user has set a required value for the core temperature (for example, in FIG. 3, 88° C.) by touching one of the display elements 18 for the browning intensity and moving the core temperature selection element 21, the user can finalize these values by making a confirmation, e.g., by touching a confirmation element 23 with a finger. It can also be provided that such confirmation is not required.

It can furthermore be provided that in the second display area 3, context-sensitive information 24 is displayed regarding the already selected operating mode “poultry” and/or the selected cooking process (i.e., “roasting/broiling” as shown), and it is clear to persons skilled in the art that this is possible on every treatment level.

After the user has confirmed their inputs via the confirmation element 23, the cooking program which has then been selected (which can thus be determined by the selected operating mode, the selected cooking process, and the set cooking parameters, and characterized by the codewords “roasting poultry”) can be assigned to a virtual token 101G in a virtual token bar 100. In FIG. 4, a virtual token bar 100 of this type is shown after three cooking programs have been selected: “roasting poultry” (the first cooking program 101G), “roasting fish” (the second cooking program 102G), and “steaming fish” (the third cooking program 103G). These cooking programs are shown as three virtual tokens 101G, 102G and 103G, which follow the selection of the cooking parameters of the third cooking program via selection elements 19′, 20′, 21′, and with the display element 22′ of the core temperature and the information 24′. Here, each cooking program is selected in the same manner as the first cooking program, which is described in detail herein. A fourth cooking program could also be selected by touching a further selection element 26.

FIG. 4 shows a fourth sub operating menu level in which the virtual token bar 100 shown in the first display area 2 covers all cooking programs confirmed by the user (displayed as virtual tokens 101G, 102G and 103G). Alternatively, it is possible to display virtual tokens in the virtual token bar 100 prior to confirmation by the user, and as an option to mark these graphically and/or using symbols in such a manner that they can be differentiated from confirmed virtual tokens.

If for example a user touches one of the virtual tokens 101G, 102G, 103B with their finger, the cooking parameters for the respective operating mode and the respective cooking process relating to the cooking program belonging to the token touched can be shown in the second display area 3, and can be adjusted according to the requirements of the user.

The virtual tokens automatically created by the cooking device according to the embodiments of the present invention can, through their color and shape, contain information regarding the extent to which a cooking program can be jointly ran with one or more other cooking programs in a mixed load, as is explained in greater detail below.

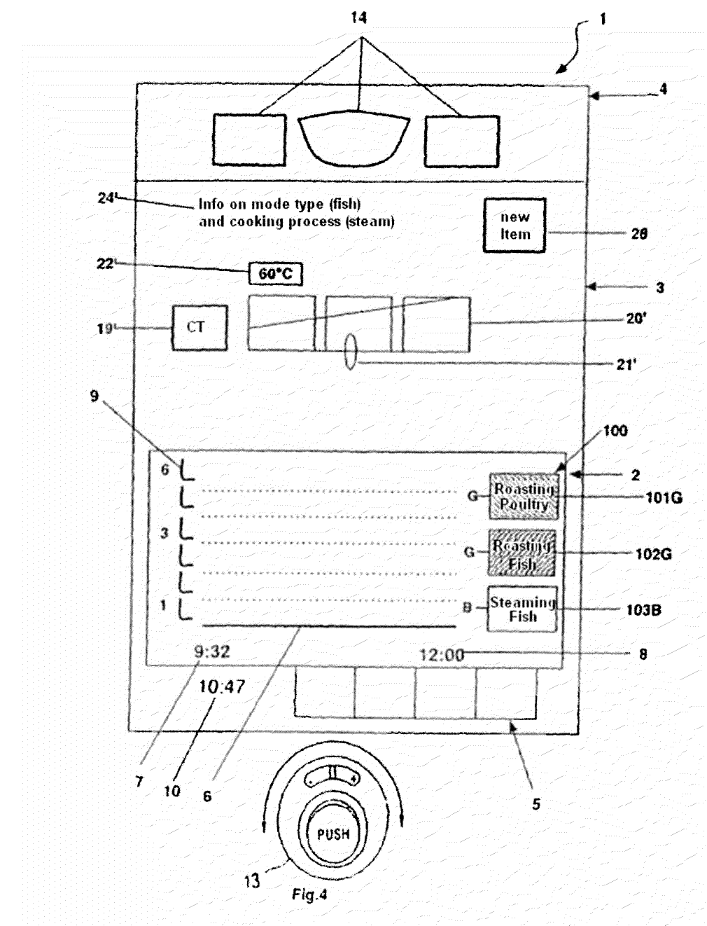

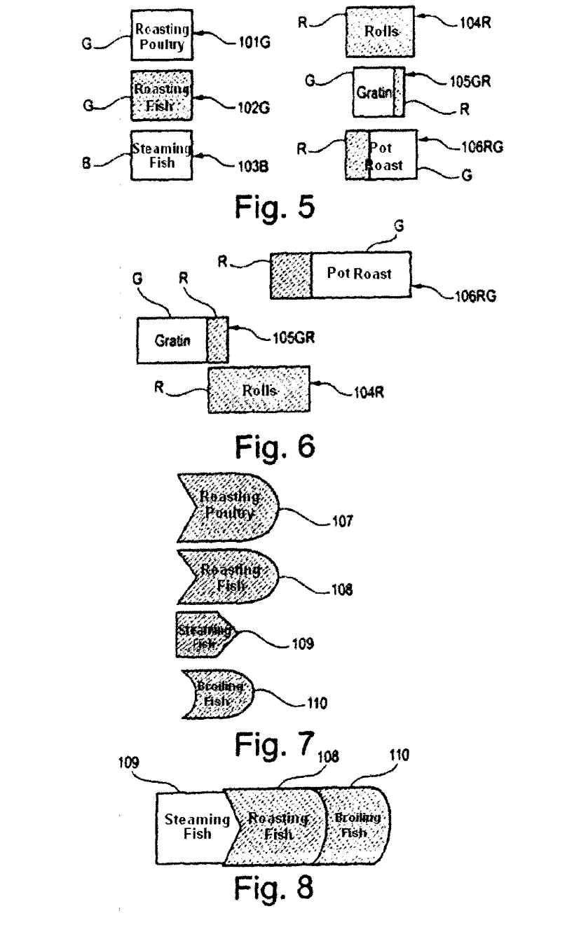

As is shown in FIG. 5, virtual tokens 101G, 102G, 103B can be marked by a color for each cooking chamber climate that is required for the cooking program belonging to the virtual token. For example, the virtual token for “roasting poultry” 101 G and the virtual token for “roasting fish” 102G may be green (G) in order to identify a cooking chamber climate in which both fish and poultry can be roasted. The virtual token for “steaming fish” 103B is marked with the color blue (B), because a steaming process must run separately, i.e., either before or after a cooking chamber climate suitable for roasting. It is clear that the selection of colors is not restricted to the colors described, but that any colors can be used for a differentiation. In any case, it can be seen that virtual tokens or virtual partial tokens of the same color identify cooking programs or cooking stages that can be implemented simultaneously in a cooking chamber because they require the same climate parameters. Here, the temperature, humidity, flow speed, pressure, and/or microwave energy in a cooking chamber can determine the climate parameters.

It can also be provided that a virtual token can be shown in more than one color. It may be necessary that an item to be cooked be run through several cooking stages before it is fully cooked, and accordingly, the individual cooking stages of the related cooking program are marked in different colors. Thus, for example, a cooking chamber climate required for a cooking program “rolls,” which is represented by a red (R) token 104R, conforms to a cooking chamber climate for a browning phase (a first cooking stage) of a cooking program “pot roast.” The dual-color token 106RG conforms to the crusting phase (a second cooking stage) required at the end of the “gratin” cooking program expressed as the dual-color token 105GR. Simultaneous cooking of the virtual tokens 104R, 105GR, 106RG, marked with red (R) areas is possible due to the identical cooking chamber climate required. It is also feasible that items to be cooked that require more than two cooking stages are marked with a respective color for each cooking stage required.

FIG. 6 shows a possible arrangement of the virtual tokens 104R, 105GR, 106RG shown in FIG. 5 in a token board on the basis of their color markings, where cooking stages with identical cooking chamber climates are shown. As shown in FIG. 6, a representation of virtual tokens 104R, 105GR, 106RG (partial tokens), which are shown in different colors, enables the user to make a simple compilation of the cooking stages with identical cooking chamber climates and as a result, efficiently prepare items to be cooked that are to be cooked in different ways. It can be clearly seen that a plurality of different items to be cooked with identical or varying cooking stages can be shown in different colors.

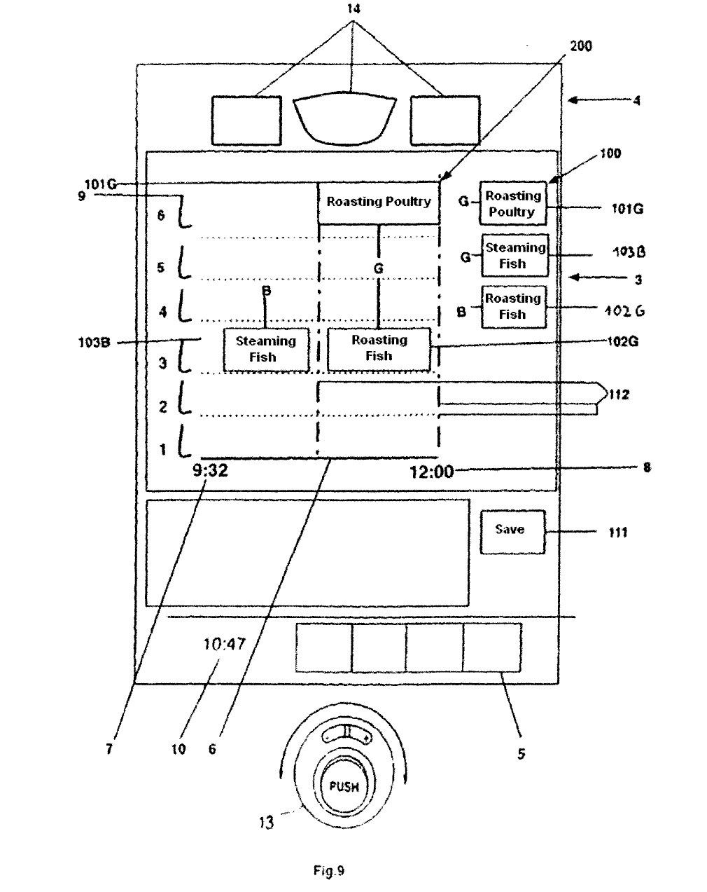

FIG. 7 shows another possible graphic representation of alternative virtual tokens for “roasting poultry” 107, “roasting fish” 108, “steaming fish” 109, and “broiling fish” 110. Instead of a color marking, as is described with reference to FIGS. 5 and 6, the virtual tokens in FIG. 7 are shown with differently shaped beginnings and/or ends. The geometric form for the virtual tokens 107, 108, 109, 110 provides a visual representation regarding cooking programs that can be cooked jointly, and provides information regarding the sequence in which different items to be cooked should be optimally cooked. The same geometry on virtual tokens means that the corresponding items to be cooked can be cooked jointly. If complementary geometries are present on two edges, such as with the left edge of the token 107 and 108, and the right edge of the token 109, it means that the cooking programs for tokens 109 and 107 or 108 can be ran in succession, as will be described below with reference to FIG. 8.

It is also feasible that in addition to a specific geometric form or geometry, virtual tokens can also have color markings. A geometric differentiation between the virtual tokens can offer the advantage, for example, that information regarding an optimum sequence for the loading of a cooking device according to the embodiments of the present invention with items to be cooked can be made visible to the user via the geometry. It can, for example, be effective in terms of energy consumption to maintain a sequence as shown in FIG. 8 when the cooking device is cold.

In FIG. 8, the cooking program for the virtual token “steaming fish” 109 first implemented in the cooking device according to the embodiments of the present invention is, in order to then maintain the middle-range temperature level resulting from the steaming when implementing the cooking program for the virtual token “roasting fish” 108, and only then implementing the cooking program for the virtual token “broiling fish” 110 at a high temperature level. This optimum sequence is made visible to the user by means of a key and lock symbol which is automatically shown graphically by the cooking device on the left and/or right edge of the virtual token 108, 109, 110. Furthermore, combinations of geometric forms on the beginning and/or end of a virtual token and a color marking can be created. Furthermore, it is clear to persons skilled in the art that each geometric form can be used to mark virtual tokens.

Before cooking items in a cooking device according to the embodiments of the present invention with a plurality of insertion levels, a time assignment and a spatial assignment of the virtual tokens to the insertion levels 9 shown in FIG. 9 and a time bar 6 are necessary. Such an assignment can either be conducted by the user or be achieved in the form of an automatic assignment by the cooking device according to the embodiments of the present invention. It can, for example, starting from the fourth sub operating menu in FIG. 4, appear automatically as a fifth sub operating menu after a certain time period has elapsed without activating a selection element.

As is shown in FIG. 9, the virtual token bar 100 with the three virtual tokens “roasting poultry” 101 G, “roasting fish” 102G, “steaming fish” 103B, is located in the second display area 3 on the right-hand side next to a virtual token board 200 on the touchscreen 1. The user has the option because of the touch function on the touchscreen 1. For example, using “drag and drop” functions, the user may pull the cooking programs represented as virtual tokens onto the insertion levels 9 at a required time point along the time bar 6 of the cooking device according to the embodiments of the present invention. Here, the user can take into account the additional information provided by the color and/or geometry of the virtual tokens.

Within the framework of the time and spatial arrangement of the virtual tokens 101G, 102G, 103B, the user can, however, be assisted by further functions which are explained in greater detail below.

A function “parking position denied” prevents virtual tokens or virtual partial tokens of different colors and/or geometries, which accordingly require different cooking chamber climates, from being arranged below or above each other at the same time point on the time bar 6 (for example on different insertion levels 9). Thus, at least a short-term time overlap of cooking programs or cooking stages that require different climate parameters (such as temperature, humidity, flow speed, pressure and/or microwave treatment) is avoided.

A further function that can assist the user is provided simply by the width of the respective virtual tokens. As can be seen in FIG. 9, when the virtual tokens 101G, 102G, 103B are transferred from the virtual token bar 100 to the time bar 6 (which is limited by a starting time point 7 for the cooking programs and an orientation time point 8), and thus into the token board 200, the width of the virtual tokens 101G, 102G, 103B changes along the time bar 6. While the virtual tokens 101G, 102G, 103B, as long as they are located in the virtual token bar 100, have an identical width, this width is shown in the token board 200 in accordance with the ratio of the duration of the respective cooking programs. Therefore, the width of a virtual token 101G, 102G, 103B also symbolizes the overall cooking time of the respective cooking program. The cooking time required for a respective cooking program may be determined by accessing empirically calculated values and/or is self-learned, i.e., as a result of previous actions by the user.

Preferably, a third supporting function “orientation lines” or “snap lines”, is also available to the user. When positioning the virtual tokens 101G, 102G, 103B, snap lines 112 in the virtual token board 200 serve to support a simple arrangement. The snap lines 112 are visible when the user pulls a virtual token 101G, 102G, 103B from the token bar 100 into the time bar 6, and/or when a virtual token 101G, 102G, 103B is moved within an insertion level 9 along the time bar 6 in time, and/or when a virtual token 101G, 102G, 103B is moved from a first insertion level to a second insertion level 9. This moving of a virtual token 101G, 102G, 103B can be achieved using “drag and drop.” The snap lines 112 show a connection between possible placement times and insertion levels 9. If the user moves one of the virtual tokens 101G, 102G, 103B using “drag and drop” close to one of the snap lines 112 from a defined distance from one of the snap lines 112 (for example, when the virtual token 101G, 102G, 103B is released), the point which lies closest to the snap lines 112 is automatically selected. It can clearly be seen that a plurality of horizontal and vertical snap lines can be shown in order to support the user, where naturally, other geometric forms of snap lines are also feasible. The snap lines can also be activated or removed by a user as required.

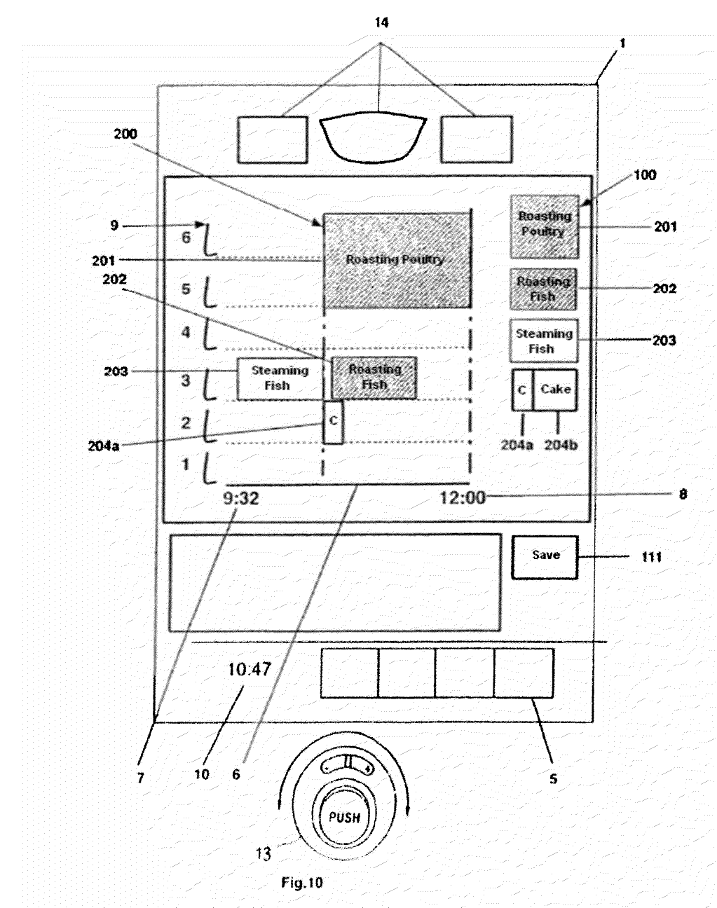

When creating a sequence plan for cooking items to be cooked a further support for the user is shown in FIG. 10 as an alternative to the fifth sub operating menu shown in FIG. 9. In the virtual token bar 100 and in the virtual token board 200, virtual tokens for “roasting poultry” 201, “roasting fish” 202, “steaming fish” 203, and “cake” 204 are shown with different heights. The height indicates an anticipated requirement for insertion levels 9. Even before placement of the tokens on one of the insertion levels 9, the user is clearly shown via the different heights of the virtual tokens 201, 202, 203, 204 the spatial requirement required by the respective cooking procedure. For example, a cooking program identified by the virtual token 201 “roasting poultry” requires two insertion levels 9 because, during a poultry roasting program, holders for items to be cooked are used which are, e.g., sold by the applicant under the trade name “Superspike.”

Furthermore, for items to be cooked, such as for cakes, the associated virtual token 204 can be divided into several partial tokens (e.g., in a virtual partial token “cake base” 204a and the virtual partial token “cake finishing” 204b). Certain items to be cooked run through several cooking stages until they reach the end of a cooking program, between which even an interim treatment stage must be conducted outside of the cooking device according to the embodiments of the present invention. For the virtual token “cake” 204, for example, first a base of the cake, as is identified by the virtual partial token 204a, is cooked at high temperatures, together with the cooking programs for the virtual tokens 201, 203. Following this, an interim treatment stage outside of the cooking device and a final cooking procedure, which is identified by the virtual partial token 204b, is conducted in a cooking chamber climate with a lower temperature (this later time point is not shown in FIG. 10).

It is clear that the height of the virtual tokens is oriented to the spatial requirement of the corresponding cooking program and does not have to be limited to two insertion levels 9. Furthermore, if required, any subdivision of virtual tokens into a corresponding required plurality of virtual partial tokens is made possible.

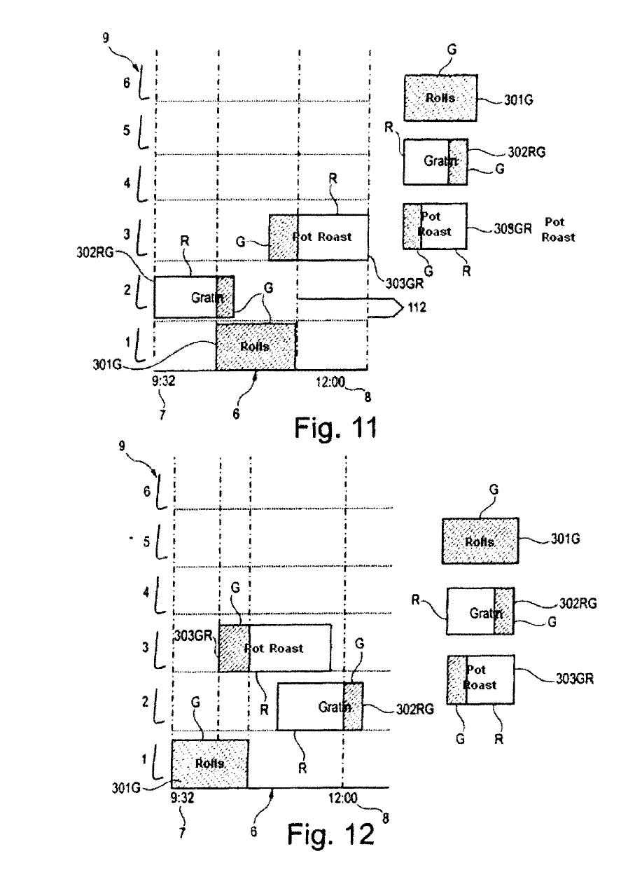

Automatic arrangements of virtual tokens in the virtual token board 200 are shown in FIGS. 11 and 12. Here, virtual tokens “rolls” 301R, “gratin” 302RG, and “pot roast” 303GR, are placed on the virtual token bar 100, and are placed at corresponding time points on the time bar 6, which is limited by the starting time point 7 and the orientation time point 8, and/or on corresponding insertion levels 9.

An automatic arrangement can be conducted automatically under different priorities, i.e., with different priority parameters, by a cooking device according to the embodiments of the present invention. It can be provided, for example, that the virtual tokens 301R, 302RG, 303GR are optimally arranged in terms of energy consumption. For example, where there is first a steam cooking stage, followed by a combined steam cooking stage and then a hot air cooking stage. This arrangement can also be made clear by the use by geometric forms of the virtual tokens 301R, 302RG, 303GR, as shown in FIG. 7 for the virtual tokens 107, 108, 109, 110. Alternatively, it is feasible that an optimum arrangement of the virtual tokens 301R, 302RG, 303GR in terms of the shortest possible use of the device with a corresponding reduction in resources (such as work time used) can be conducted. In general, an optimization of the arrangement is also possible under other parameters in the cooking device according to the embodiments of the present invention and is clearly not limited to the examples given.

An exemplary arrangement of the virtual tokens 301R, 302RG, 303GR is shown in FIG. 11. If the user is dissatisfied with the recommended automatic assignment of the virtual tokens 301R, 302RG, 303GR, a re-prioritization can be conducted by the user, which can lead to a re-arrangement of the virtual tokens 301R, 302RG, 303GR, e.g., according to FIG. 12. If the user desires that the cooking program for the virtual token “rolls” 301R is to be implemented at an earlier time point, the user can bring forward the virtual token using “drag and drop,” for example, from the time point shown in FIG. 11 on the time bar 6 to an earlier time point. After the user has re-prioritized, it is feasible that an automatic re-arrangement of the time points and the respective insertion levels of the remaining virtual tokens 302RG, 303GR is automatically conducted by the cooking device according to framework conditions selected by the user. It can be clearly seen that any required re-prioritizations can be initiated by the user, with a corresponding automatic adaptation of the time progression and/or of the spatial arrangement of the cooking programs according to the selected virtual tokens by the cooking device according to the embodiments of the present invention.

Furthermore, it is feasible that a user is shown a critical path (not shown) that includes virtual tokens which must necessarily be loaded or unloaded at certain time points in order to conform to the required sequence plan.

It can also be provided that a user can set the time period shown on the time bar 6 as required, for example by specifying a display time period via a starting time point 7 or an orientation time point 8. Additionally, a time period shown can be moved along the time axis. According to the required time period of the display of a sequence plan, the size of virtual tokens can automatically be adjusted by the cooking device according to the embodiments of the present invention. A selection of a required time period is not limited to the options described—it is also possible for a user to determine a display time period using a gesture control, or to use other means suitable for this purpose.

It is generally also possible not only to display the representation in the area of the virtual token board 200 two-dimensionally, but also three or even four-dimensionally. With three dimensions, the user would have two location coordinates (position axes) and a time coordinate (time axis), while a four-dimensional representation would enable a representation of the three-dimensional area over time. The location coordinates can be used to precisely specify treatment zones within a cooking chamber, for example via the number of an insertion level and the arrangement of a treatment zone within an insertion level. Because every user has different preferences, it is possible for the user to select how many dimensions the token board 200 should have, and which dimensions should be applied. With the token boards 200 described above, only one location coordinate has been selected (namely for the number of an insertion level 9), and a time coordinate has been selected (namely in the form of a time bar 6), in order to keep the representations simple. The selected representations should therefore not be regarded as a limitation, but as a plurality of variation options that are provided for a method according to the embodiments of the present invention in order to provide the representation required in each case for users with different needs.

Further flexibility in the representation is also made possible because a user can select the dimension of the representation, and can also select a reduction in size, an enlargement, or a displacement of the display area. It is also possible to enable spatial representations to move around over time, etc.

Furthermore, at least one progress bar can be shown, which represents the progress of at least one cooking program over time. Every cooking program, and thus every virtual token in the virtual token board, can be assigned a progress bar. Here, it is particularly expedient that a user can select whether and, if appropriate, how many progress bars should be shown. It is clear that in order to represent the progress bars, every graphic representation suitable for this purpose can be used, and that this graphic representation can be placed on, adjacent to, or close to the respective virtual tokens, insofar as an assignment of the progress bars to the virtual tokens can be clearly recognized. Here, it is irrelevant whether the assigned is made with virtual tokens on the virtual token board, or along the time bar 6. Alternatively or in addition to a representation of one or more progress bars, a numeric representation of a residual cooking time can be made. Furthermore, any arrangement of the overall progress bar is possible, as is a numeric value of an overall residual cooking time.

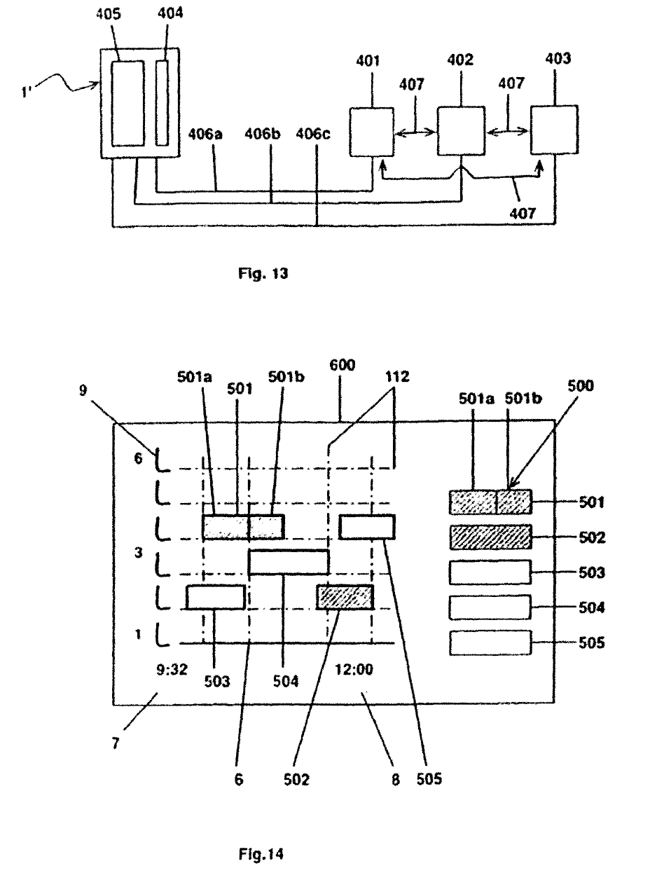

An input and display device in the form of a device separate from a cooking device shown in FIG. 13 (for example a touchscreen 1′ arranged in a service station) can also be used for the central control of one or more cooking devices 401, 402, 403. For this purpose, a virtual token bar 404 and a virtual token board 405 are located on the touchscreen 1′, either for all cooking devices 401, 402, 403 that are connected to the touchscreen 1′, or for only one of these cooking devices 401, 402, 403. An interconnection of the cooking devices 401, 402, 403 or with the touchscreen 1′ can be achieved via network cables 406a, 406b, 406c. Alternatively, it can be provided that the touchscreen communicates with a plurality of cooking devices 401, 402, 403 via wireless LAN. It can also be provided that the cooking devices 401, 402, 403 are connected to each other via a bus system 407, and that the input to a display device according to the embodiments of the present invention is provided in the form of a touchscreen on each of the cooking devices 401, 402, 403 in order to enable a distribution of virtual tokens to each cooking device 401, 402, 403 for the plurality of cooking devices.

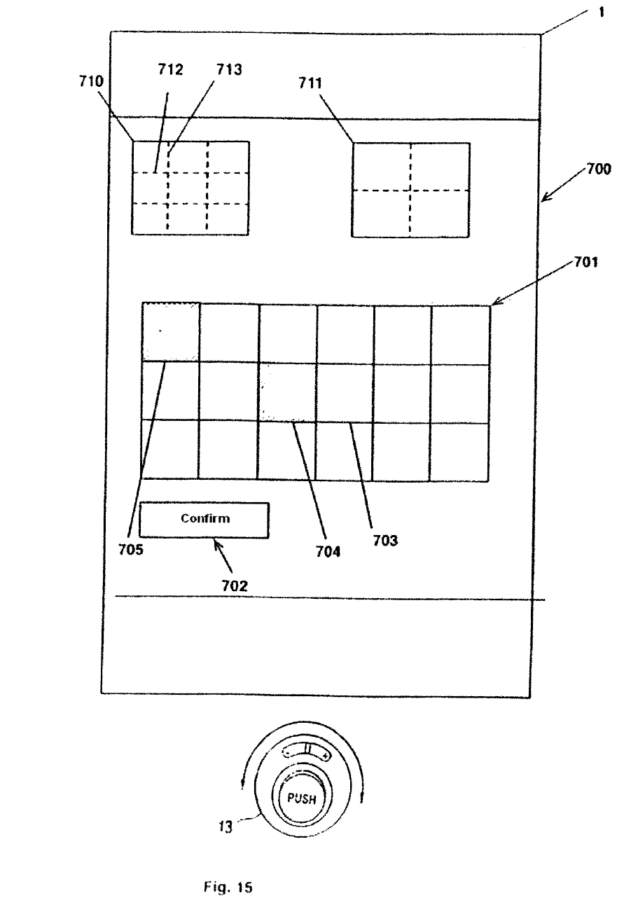

In FIG. 14, virtual tokens 501, 502 for items that must be cooked for a fixed time are shown in a virtual token bar 500, and additional virtual tokens 503, 504 and 505 for items to be cooked, which have not had time specifications set by the user, are also shown. These different time specifications are visually marked by hatching or non-hatching. Any manual movements in the time sequence of the cooking programs for the virtual tokens 503, 504, 505 have no influence on a cooking time point of the cooking programs for the virtual tokens 501, 502. It can be provided, for example, that a cooking program that is divided into two cooking stages (and thus into two partial tokens 501a, 501b′) must be fully cooked at a specific time prior to a lunch buffet, while a cooking program for the virtual token 502 should be fully cooked for a potential buffet opening at 12:08 pm. Therefore, only the tokens 501 and 502 must be placed at certain positions relative to the time bar 6 in the virtual token board 600, while the other virtual tokens 503, 504, 504 on the virtual token board can optimally be arranged around the virtual tokens 501, 502 according to parameters required by the user.

It is clear that any number of virtual tokens required can be assigned a fixed implementation time, where this either enables a fixed starting time 7 and/or a fixed end time 8 of the cooking program (for example, for rolling loading or removal). Furthermore, it is clear that the described functions can be combined in order to support the user when creating a sequence plan by assigning a fixed implementation time to certain virtual tokens 501, 502.

As shown in FIG. 15, for a spatial arrangement of the virtual tokens, a fourth display 700, can be shown with virtual treatment zones 701. After virtual tokens are placed on one of the insertion levels 9, as shown in FIG. 9 for example, the virtual treatment zones 701 can be displayed, either at the request of the user or automatically. Here, treatment zones 703 that have not yet been allocated, and the treatment zones 704, 705 that have already been allocated, are marked differently, e.g., using a different color and/or hatching in each case, in such a manner that the user can recognize which treatment zones 703, 704, 705 it is possible to place virtual tokens that have not yet been spatially assigned. Here, it can be provided that the number of treatment zones required for virtual tokens is made clear to the user prior to placement on the virtual treatment zones 701. This can be achieved, for example, on the basis of virtual tokens 710, 711 shown in such a manner that the number of treatment zones required in each case (e.g., 9 treatment zones with virtual token 710 or 4 treatment zones with the virtual token 711) is identified by horizontal and vertical lines. Alternatively, it is also possible to display a required number numerically close to, adjacent to, and/or on a virtual token.

It is clear that when the virtual tokens 710, 711 are placed on the virtual treatment zones 701 further functions can support a user making the placement. For example, an automatic blocking function can be provided that automatically prevents a virtual token 710, 711 from being placed on treatment zones 704, 705 that are at least already partially allocated. An automatic assignment can also be made that takes into account treatment zones which are still available. If required virtual tokens are assigned to corresponding virtual treatment zones, it can be provided that a user then must confirm the selection made by means of a confirmation element 702.

Additionally, it is clear that a plurality of free treatment zones can be shown in accordance with the virtual treatment zones 701 shown, and they can be shown simultaneously for several insertion levels of a cooking device and/or a plurality of cooking devices. A plurality of virtual tokens can also be shown with any number of required virtual treatment zones.

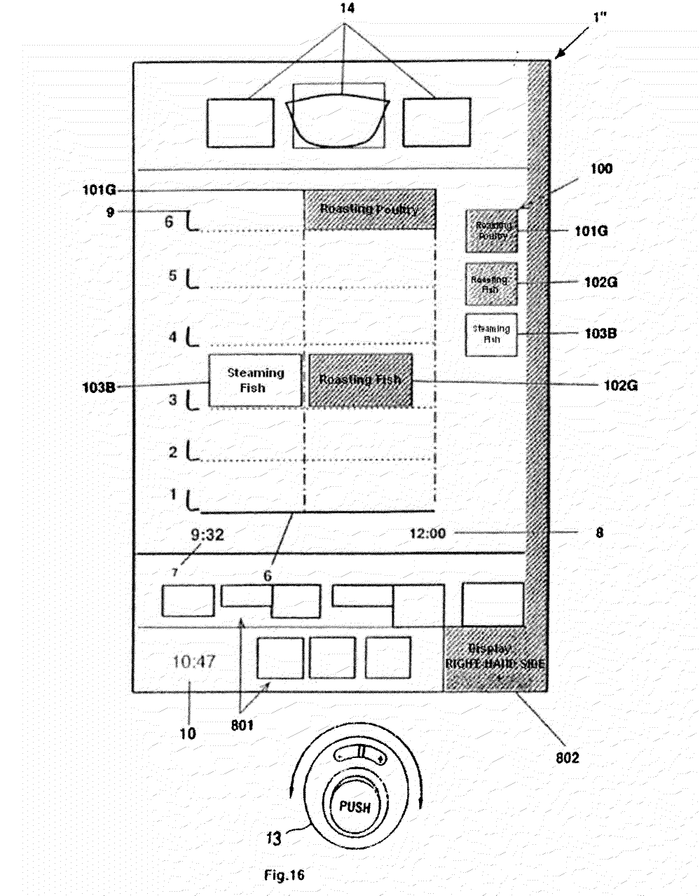

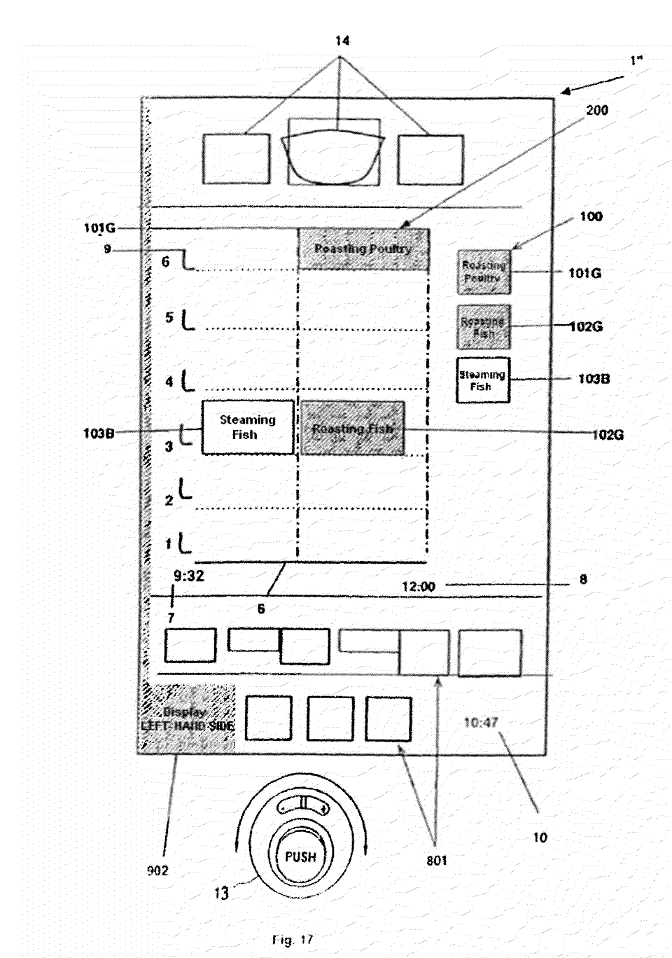

The option of altering the display between two treatment areas, e.g., in the form of at least two pans and/or at least two levels of a cooking device, is shown in FIGS. 16 and 17. A required display alteration can be achieved in such a manner that a display alteration area 802, 902 is shown on a touchscreen 1″, which can also be designed as a display area of a further pan and/or a further level which is reduced in size, has a different color marking, a different shape, is hatched, positioned, and/or is assigned a different level of brightness. FIGS. 16 and 17 differ in the arrangement of the respective display alteration area 802, 902. In FIG. 16, the display alteration area 802 is on the lower right-hand side, and in FIG. 17 the display alteration area 902 is on the lower left-hand side. Moving a virtual token bar 100, a virtual token board 200, and/or at least one of the virtual tokens 101G, 102G, 103B (e.g., using “drag and drop”) onto the display alteration area 802, 902, can result in a display for the further pan and/or the further level. Here, it can be provided that the virtual token bar 100 and/or the virtual token board 200 lead to a movement of the token bar 100 and/or the token board 200 by touch and movement on the display alteration area 802, 902.

Alternatively, it is clear that an individual virtual token 101G, 102G, 103B can be moved onto the display alteration area 802, 902 from the virtual token bar, and/or from the virtual token board 200 onto a virtual token bar. Here, it is also feasible that after moving a virtual token board 200, a virtual token bar 100, and/or a virtual token 101G, 102G, 103B onto the display alteration area 802, 902, no direct placement is made by releasing. It can also be provided that when retaining hold, an alteration is made in the display of the touchscreen 1″, so that for example the virtual tokens 101G, 102G, 103B can be placed directly on a required insertion level and/or at a required time point on a further virtual token board, and/or on a virtual token bar, and that following placement, an automatic alteration can be made back to the previous display.

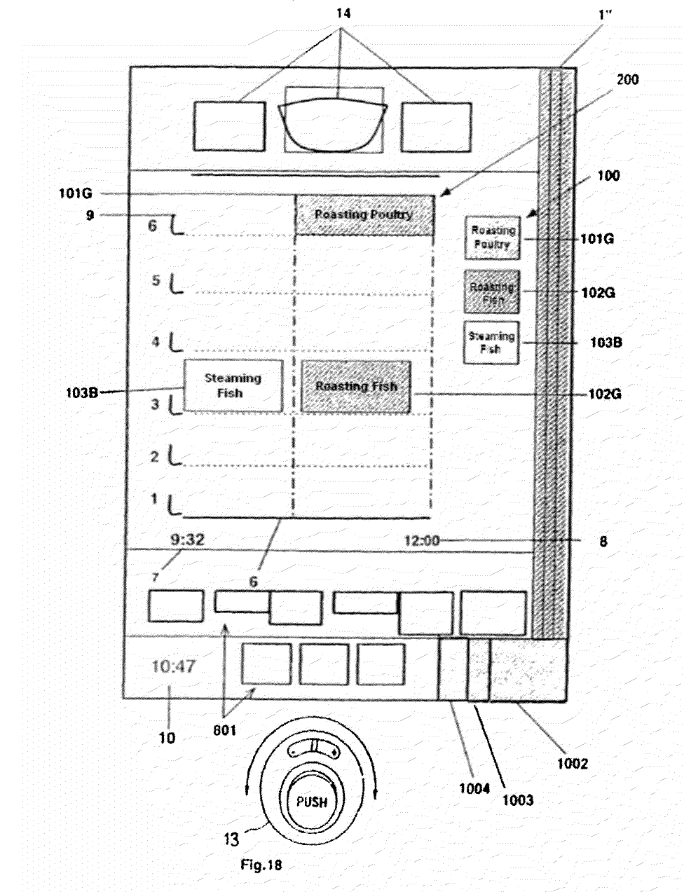

An alteration between different display areas that represent treatment areas, treatment zones, pans, and/or cooking devices, is naturally not restricted solely to the two display alteration areas 802, 902 described above. To a far greater extent, as is shown in FIG. 18, it can also be provided that a display alteration between more than two display areas of a cooking device and/or a display alteration between a plurality of cooking devices that are networked with each other requires a large number of display alteration areas 1002, 1003, 1004. Thus, in addition to one display alteration area 1002 (for example, for a display alteration between levels of a cooking device), display alteration areas 1003, 1004 can also be provided for at least two further cooking devices. Here, it is clear that any number of display alteration areas can be shown. It can also be provided that every display alteration area is assigned to a certain cooking device and/or a certain level by means of a color marking, hatching, a geometric form, or similar, where, e.g., each cooking device can be assigned a specific color, and display areas can be differentiated by means of hatching and/or a geometric shape.

The features of the embodiments of the present invention disclosed in the above description, in the claims, and in the drawings, can be essential both individually and in any combination required in order to realize the invention in its different embodiments.

### List of Reference Numerals

1, 1′, 1″ Input/output device in the form of a touchscreen
2 First display area
3 Second display area with operating menus
4 Third display area
5 Buttons
6 Time bar
7 Starting time point for the cooking programs
8 Orientation time point
9 Insertion/Loading levels
10 Current time
11 Cooking mode type selection element
12 Selection element of the selected cooking mode type (e.g., poultry)
13 Operating element
14 Display fields
15 Cooking process selection element
16 Selection element of the selected cooking process (e.g., roasting/broiling)
17 Browning display element
18 Browning intensity display element
19, 19′ Core temperature display element
20, 20′ Core temperature level display element
21, 21′ Core temperature selection element
22, 22′ Display element for the selected core temperature
23 Confirmation element
24, 24′ Context sensitive information
26 Selection elements for further cooking program
100, 100′ Virtual token bar
101G Virtual token “roasting poultry”
102G Virtual token “roasting fish”
103B Virtual token “steaming fish”
104R Virtual token “rolls (red)”
105GR Virtual token “gratin (green/red)”
106RG Virtual token “pot roast”
107 Virtual token “roasting poultry”
108 Virtual token “roasting fish”
109 Virtual token “steaming fish”
110 Virtual token “broiling fish”
111 Selection element, storage (“save”)
112 Snap lines
113 Second display area
200 Virtual token board
201 Virtual token “roasting poultry”
202 Virtual token “roasting fish”
203 Virtual token “steaming fish”
204 Virtual token “cake”
204a Virtual partial token “cake base”
204b Virtual partial token “cake finishing”
301G Virtual token “rolls”
302RG Virtual token “gratin”
303RG Virtual token “pot roast”
304 Starting time point of the cooking programs
305 Orientation time point
401 Cooking device
402 Cooking device
403 Cooking device
404 Virtual token bar
405 Virtual token board
406a, b, c Network cable
407 Bus system
500 Virtual token bar
501 Virtual token
501a Virtual partial token
501b Virtual partial token
502 Virtual token
503 Virtual token
504 Virtual token
505 Virtual token
600 Virtual token board
R Red
G Green
B Blue
700 Fourth display area with virtual treatment zones
701 Virtual treatment zones
702 Confirmation element
703 Allocated treatment zone
705 Allocated treatment zone
710 Virtual token with 9 treatment zones
711 Virtual token with 4 treatment zones
712 Horizontal line
713 Vertical line
801 Display fields
802 Display alteration area
902 Display alteration area
1002 Display alteration area
1003 Display alteration area
1004 Display alteration area

1-15. (canceled)

16. A method of selecting and arranging program representatives and a cooking device therefor, the method comprising:
displaying a plurality of program representatives representing a plurality of programs on a display device, wherein the programs are programs for at least one cooking device, and wherein the plurality of programs for the at least one cooking device are stored on a storage device;
selecting a program representative from the plurality of program representatives via an input device, wherein the display device is connected to the input device and a control device, wherein the control device is operatively connected to the storage device, wherein the control device is connected to the at least one cooking device or is provided by the cooking device, and wherein the control device is operative connected to the display device in such a manner that at least one program representative is displayed in the form of a virtual token in an area on a virtual token board displayed on the display device;
displaying the virtual token board on the display device;
displaying the at least one program representative in the form of a virtual token on the virtual token board by:
placing the virtual token on a first section of an area on the virtual token board by touching or approaching the first section of the area of the virtual token board; and/or
moving the virtual token from a second section of the area on the virtual token board to a third section of the area on the virtual token board by touching or approaching the second section and moving or stroking the virtual token over to the third section; and/or
touching or approaching at least a fourth section of the area on the virtual token board, or removing the virtual token from the fourth section; and/or
altering a visual representation of an input activity;
enabling a representation of a process for cooking via the virtual token board in order to determine when and how to place an item to be cooked in a treatment zone of the at least one cooking device,
wherein the representation is displayed within a multidimensional area comprising a coordinate system with at least two position axes,
wherein at least one of the axes is a position axis in order to determine a treatment level, treatment gap, or treatment line of a cooking area of the at least one cooking device, and
wherein at least one of the axes is a time axis in order to determine at least one time point of an operation of the at least one cooking device.

17. The method of claim 16, wherein the plurality of programs are programs comprising:
cooking programs including cooking mode types, cooking processes, cooking parameters, and/or items to be cooked;
cleaning programs including cleaning mode types, cleaning processes, cleaning parameters, and/or cleaning agents;
auxiliary programs; and/or
diagnostics programs, and
wherein each virtual token comprises a code name and/or a graphic representation for its corresponding program.

18. The method of claim 16, wherein the coordinate system of the virtual token board (i) determines via a first position axis at least one treatment level of a cooking chamber of the at least one cooking device, (ii) determines via at least a second position axis at least one treatment zone of a treatment level of the at least one cooking device, and/or (iii) determines via a time axis at least one time point or time period of at least of one selected program, function plan, and/or function sequence.

19. The method of claim 16, further comprising:
displaying selectable virtual tokens or selected virtual tokens in at least one virtual token bar in a further area of the display device,
wherein virtual tokens in the token bar can be arranged below, alongside, and/or on top of each other, and
wherein the virtual tokens can be arranged in the chronology of the selection of corresponding programs, or the virtual tokens can be arranged automatically depending on at least one priority parameter determined by energy consumption, water consumption, cleaning agent consumption, a time requirement, a target time, a start time, an area requirement, a reduction of weight loss of an item to be cooked, contamination, creation of smoke, creation of odor, an improvement of a program result, a date of expiration, a sensitivity, a quantity, a price of an item to be cooked, and/or at least one climate parameter determined by a temperature, humidity, pressure, flow speed, and/or microwave energy.

20. The method of claim 16, further comprising:
selecting a virtual token by selecting a stored program, altering a stored program, duplicating a virtual token, and/or compiling a new program; and/or
forming a virtual token from at least two partial virtual tokens.

21. The method of claim 19, wherein at least one virtual token or partial virtual token is placed or displayed before a spatial and/or time-related arrangement in the virtual token bar on the virtual token board via the input device according to a time and/or spatial assignment in the virtual token bar on the virtual token board.

22. The method of claim 16, wherein an alteration of a token, a partial token, a token board, or a token bar via the input device results in an alteration in the visual representation, an alteration of its position on the display device, and/or an alteration of a program or program sequence.

23. The method of claim 22, wherein the alteration must be confirmed.

24. The method of claim 16, further comprising:
touching, approaching, removing, stroking, pulling apart and/or drawing together, and/or using a “drag and drop” procedure on a virtual token by moving an auxiliary tool on a touchscreen, wherein the auxiliary tool is a pen, pointer, finger, and/or cursor;
achieving an enlargement in size of an item displayed on the touchscreen by spreading apart at least two fingers; and/or
achieving a decrease in size of an item displayed on the touchscreen by removing or drawing together at least two fingers; and/or
achieving a displacement and/or duplication of an item displayed on the touchscreen by using a “drag and drop” procedure with the auxiliary tool.

25. The method of claim 22, further comprising:
performing a program alteration or a program sequence alteration using a program alteration menu or program sequence alteration menu,
wherein during the program alteration or program sequence alteration, the virtual token board or the virtual token bar is displaced at least partially, reduced in size, enlarged in size, or visually suppressed.

26. The method of claim 16, further comprising:
selecting at least one virtual token or one partial virtual token;
visually emphasizing at least one virtual token or one partial virtual token at least over a particular time period after its selection;
automatically terminating the visual emphasis with (i) a placement of the virtual token or the partial virtual token in the first section, (ii) a displacement of the virtual token or the partial virtual token from the second section into the third section, (ii) an alteration of the virtual token or the partial virtual token in the fourth section, and/or (iv) a positioning of the virtual token or the partial virtual token from a virtual token bar into the virtual token board.

27. The method of claim 16, wherein following selection or duplication, at least one virtual token or partial virtual token is automatically displaced by the control device from a virtual token bar to the virtual token board either manually via a “drag and drop” procedure or via an automation parameter determined by an access authorization, a time period in which no entry is made in the input device, and/or by at least one priority parameter or climate parameter,
wherein a manual displacement is made possible during the time period when the token is visually emphasized, and
wherein a duplication is affected by multiple touching of the virtual token or via a further input activity.

28. The method of claim 16, wherein the virtual token board further comprises at least one orientation line in the form of a snap line or a critical path, for simplifying the positioning of virtual tokens or partial virtual tokens using a “drag and drop” procedure,
wherein the orientation line is at least partially displayed following a query via the input device,
wherein when the orientation line is a critical path, display of the orientation line depends on a priority parameter or climate parameter, and
wherein a plurality of orientation lines are selected in order to determine treatment zones or time points.

29. The method of claim 19, wherein the priority parameter, climate parameter, an automation parameter, and/or at least one orientation line can be selected and altered.

30. The method of claim 16, wherein the display device selectively displays at least one virtual token, partial virtual token, token bar or virtual token board of a first or second cooking device, or of at least two cooking devices.

31. A cooking device using a method for selecting and arranging program representatives, the cooking device comprising:
an input device that is connected to the cooking device or is integral with the cooking device;
a control device that is operatively connected to the input device;
a display device that is connected to the cooking device or is integral with the cooking device;
a storage device that is connected to the cooking device or is integral with the cooking device;
at least one function device for implementing at least one program, wherein the at least one program comprises a method for selecting and arranging program representatives;
a cooking chamber having an atmosphere therein;
a heating device comprising at least one of: an electric heating element, a gas burner, a heat exchanger, or a device for radiating electromagnetic radiation into the cooking chamber in the form of a microwave source;
a device for introducing humidity into the cooking chamber comprising at least one of: a steam generator, a water atomizer, or a vaporization device;
a device for removing humidity from the cooking chamber comprising at least one of a fresh air feed or a condenser;
a device comprising a fan or a pump for circulating the atmosphere of the cooking chamber;
a device comprising at least one blocking device for pressurizing the cooking chamber; and
a cleaning device.

32. The cooking device of claim 31, wherein the cooking device, the control device, the display device, the input device, and/or the storage device can be connected to a plurality of additional cooking devices in order to provide a kitchen network.
